(19) United States
(12) Patent Application Publication
(10) Pub. No.: US 2026/0121840 A1
(43) Pub. Date: Apr. 30, 2026

(54) AGENTLESS SINGLE SIGN-ON TECHNIQUES

(71) Applicant: CyberArk Software Ltd., Petach-Tikva (IL)

(72) Inventors: Tomer DAYAN, Petach-Tikva (IL); Yaron NISIMOV, Kfar Saba (IL)

(73) Assignee: CyberArk Software Ltd., Petach-Tikva (IL)

(21) Appl. No.: 19/426,914

(22) Filed: Dec. 19, 2025

Related U.S. Application Data
(63) Continuation-in-part of application No. 19/343,421, filed on Sep. 29, 2025.
Application No. 19/343,421 is a continuation of application No. 17/806,698, filed on Jun. 13, 2022, now Pat. No. 12,432,048.

(51) Int. Cl. H04L 9/08; H04L 9/32

(52) U.S. Cl. CPC H04L 9/0825; H04L 9/0852; H04L 9/3213; H04L 9/3239

(57) ABSTRACT

Described herein are methods, systems, and computer-readable storage media for using a network identity. Techniques may include encrypting a first data element and storing the encrypted first data element mapped to a network identity. Techniques may further include receiving a request from the network identity to perform an action on a resource, dynamically determining a second data element, decrypting the first data element using the second data element, and performing the action on the resource using the first data element.

### CROSS-REFERENCE TO RELATED APPLICATION

The present application is a continuation-in-part of, and claims the benefits of priority to, U.S. Application No. 19/343,421, filed on September 29, 2025, which is a continuation of, and claims the benefits of priority to, U.S. Application No. 17/806,698, now U.S. Patent No. 12,432,048, filed on June 13, 2022, which are incorporated by reference in their entirety.

### TECHNICAL FIELD

This disclosure is related to agentless single sign-on techniques for network identities to access various types of resources. In some embodiments, for example, this disclosure relates to systems and methods for generating and storing data required to automatically perform actions with single sign-on when network identities access network resources.

### BACKGROUND

Network identities, including users and computing devices, often require access to various resources directly or through a gateway. Existing approaches to manage this access typically rely on protocol-bound secret services that require explicit support and custom logic for each native protocol. This approach limits applicability and increases operational complexity, as each new protocol requires custom implementation. Additionally, many systems use policy engines that map a single stored secret to broad classes of requests without fine-grained per-request differentiation. These methods often result in coarse-grained access control, where one secret per identity or gateway cannot express nuanced, request-dependent access.

Such traditional approaches share several limitations. First, they suffer from protocol lock-in because solutions depend on protocol-specific secret exchange mechanisms. This dependency makes it challenging to adapt to new protocols or modify existing ones without significant rework. In addition, the coarse-grained access control limits the ability to provide tailored permissions based on specific request contexts. Finally, these methods often exhibit poor replay and session resistance when secrets are not tied to negotiation-specific data (e.g., nonces, timestamps, IDs, challenges, etc.), potentially compromising security.

According to the techniques described herein, secure access to resources over a network by network identities can be achieved via a gateway utilizing data packets of existing communication protocols. This approach includes additional information related to actions to perform on trusted resources without being bound to specific protocols. The system can adapt to various protocols and provide fine-grained access control based on request-specific contexts. Further, the additional information shared between network identities and a gateway can be secured using encryption technologies.

Thus, in view of these types of network vulnerabilities, there is a need for technological solutions to manage network identities’ access to resources that overcome the limitations of protocol-bound services and coarse-grained policy engines. Such solutions should be secure, should not require an overly complex setup, and should not expose a single point of failure. Such solutions will advantageously, as described herein, offer a more flexible and adaptable approach that allows for fine-grained access control and improved security across various protocols and request contexts. Further technical improvements are described in the example embodiments below.

### SUMMARY

Certain embodiments of the present disclosure relate to a non-transitory computer readable medium including instructions that are executable by at least one processor to perform operations when using a network identity. The operations may include encrypting a first data element, storing the encrypted first data element, wherein the encrypted first data element is mapped to a network identity, receiving a request from the network identity or from an additional

network identity associated with the network identity to perform an action on a resource, dynamically determining a second data element based on fields of a communication protocol, decrypting the first data element using the second data element, and performing the action on the resource using the first data element.

According to some disclosed embodiments, the operations may further comprise identifying data associated with at least one of the network identity, additional network identity or the request.

According to some disclosed embodiments, identifying relevant standard fields of the communication protocol is based on the identified data.

According to some disclosed embodiments, the identified data includes at least one of a username of the network identity or the additional network identity, a group the network identity or the additional network identity is associated with, a role the network identity or the additional network identity is associated with, a type of authentication used for the network identity or the additional network identity, an internet protocol (IP) address associated with the network identity or the additional network identity, a type of client associated with the network identity or the additional network identity, a location of the network identity or the additional network identity, a network provider for the network identity or the additional network identity, a license associated with the network identity or the additional network identity, a type of native communication protocol, a selected cipher suite, the resource associated with the request, metadata associated with the resource associated with the request, the action associated with the request, the communication protocol, secure zone information, a time of the request, or a device identifier.

According to some disclosed embodiments, decrypting the first data element is based on the identified data.

According to some disclosed embodiments, determining the second data element is based on identified data associated with at least one of the network identity or the request.

According to some disclosed embodiments, the operations may further comprise obtaining a plurality of first data elements.

According to some disclosed embodiments, decrypting the first data element is performed dynamically.

According to some disclosed embodiments, encrypting the first data element comprises encrypting the plurality of first data elements.

According to some disclosed embodiments, storing the encrypted first data element comprises storing the plurality of encrypted first data elements.

According to some disclosed embodiments, each encrypted first data element of the plurality of encrypted first data elements is mapped to the network identity.

According to some disclosed embodiments, the operations may further comprise identifying data associated with at least one of the network identity, the additional network identity or the request, and identifying a relevant encrypted first data element of the stored plurality of encrypted first data elements based on the identified data.

According to some disclosed embodiments, storing the encrypted first data element comprises storing the plurality of encrypted first data elements with metadata associated with each encrypted first data element.

According to some disclosed embodiments, identifying the relevant encrypted first data element is performed by a machine learning model.

According to some disclosed embodiments,

the machine learning model comprises a large language model.

Certain embodiments of the present disclosure relate to a computer implemented method. The method may include encrypting a first data element, storing the encrypted first data element, wherein the encrypted first data element is mapped to a network identity, receiving a request from the network identity or from an additional network identity associated with the network identity to perform an action on a resource, dynamically determining a second data element based on fields of a communication protocol, decrypting the first data element using the second data element, and performing the action on the resource using the first data element.

Certain embodiments of the present disclosure relate to a non-transitory computer readable medium including instructions that are executable by at least one processor to perform operations when using a network identity. The operations may include obtaining a first data element, encrypting the first data element, storing the encrypted first data element, wherein the encrypted first data element is mapped to a network identity, receiving a request from the network identity to perform an action on a resource, authenticating the network identity, decrypting the first data element, based on a determination that a trigger event associated with the authentication has occurred, wherein the trigger event is configured using a configuration setting stored in association with the action provided in the request, and enabling the action on the resource using the first data element.

According to some disclosed embodiments, the first data element is generated by an authentication engine based on data sent by the network identity.

According to some disclosed embodiments, the first data element comprises a credential required to access the resource.

According to some disclosed embodiments, the encrypted first data element is stored in a memory location that is inaccessible to the network identity until authentication is complete.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram showing various exemplary components of an authentication system, according to some embodiments of the present disclosure.

FIG. 2A shows an exemplary generation of data elements, according to some embodiments of the present disclosure.

FIG. 2B shows an exemplary usage of data elements, according to some embodiments of the present disclosure.

FIG. 3 is a block diagram of an exemplary computing device used to implement a code execution management system of FIG. 1, according to some embodiments of the present disclosure.

FIG. 4 is a flowchart depicting operations of an exemplary method of performing operations when using a network identity, according to some embodiments of present disclosure.

FIG. 5A shows an exemplary generation of data elements, according to some embodiments of the present disclosure.

FIG. 5B shows an exemplary usage of data elements, according to some embodiments of the present disclosure.

FIG. 6 is a flowchart depicting operations of an exemplary method of performing operations associated with a network identity, according to some embodiments of present disclosure.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof may occur or be performed simultaneously, at the same point in time, or concurrently. Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms, thus, cover both active forms, and passive forms, of sending and receiving.

Systems and methods consistent with the present disclosure are directed to secure and adaptable agentless access to resources to perform actions. Systems and methods described below include techniques of utilizing a gateway to manage data required to access resources to perform actions requested by network identities. In some embodiments, the disclosed techniques can include securing data using encryption techniques. As described below, secured data passed as part of communication packets using existing protocols can result in various technological improvements to perform authentication and other actions in an agentless manner on an underlying system, hardware, and software, and other applications.

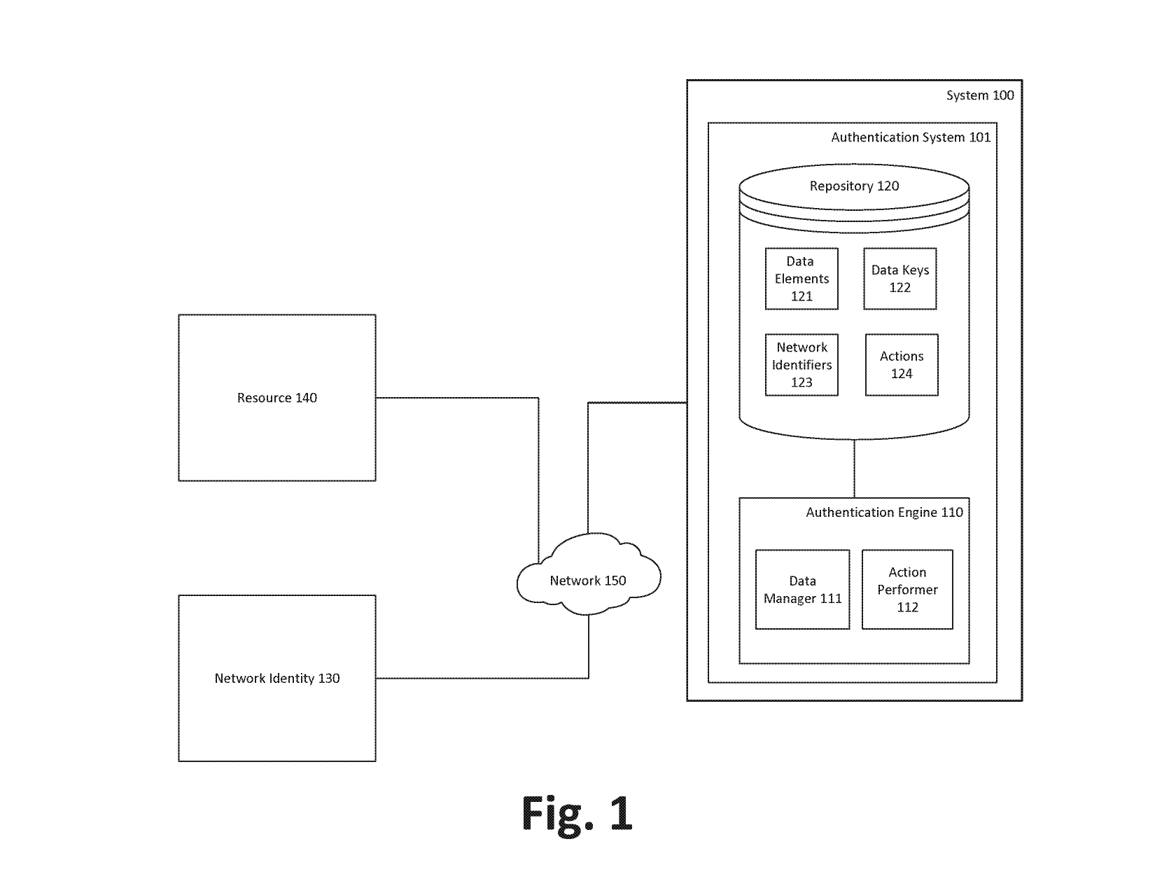

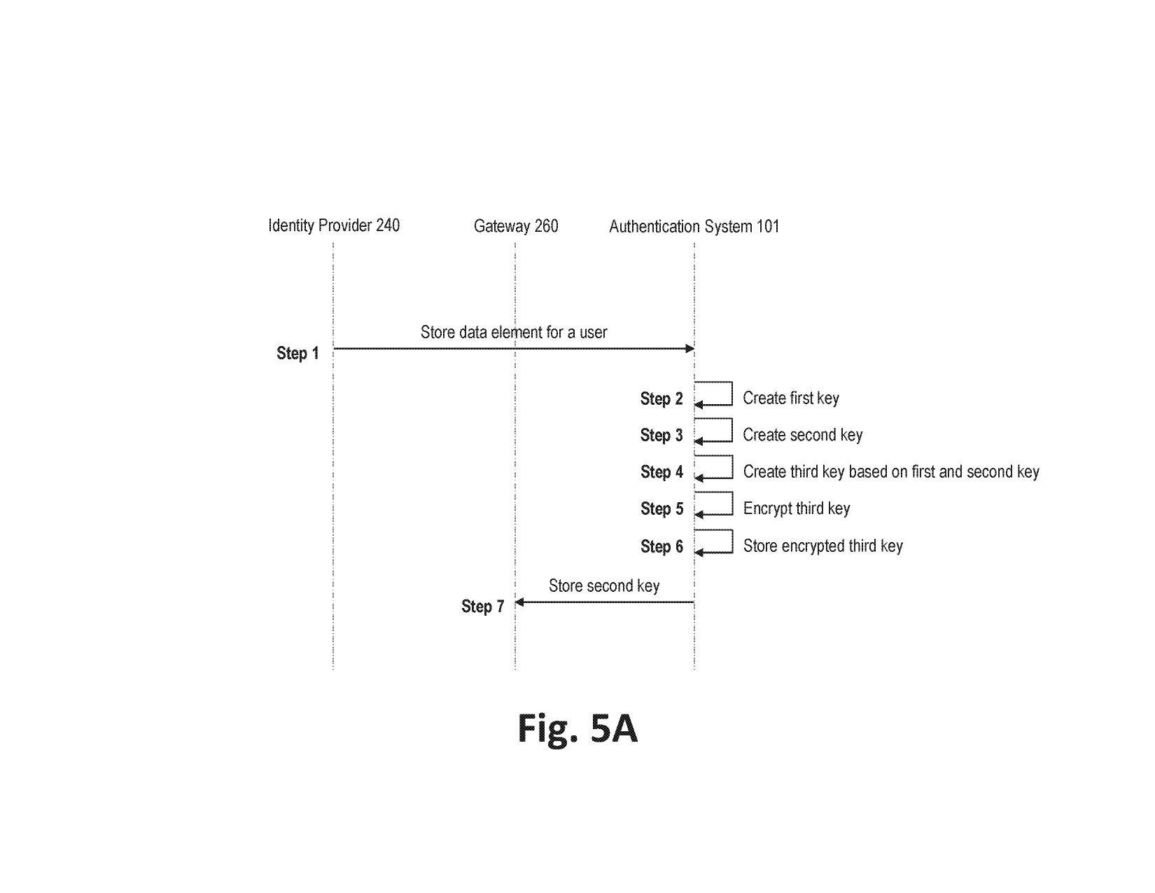

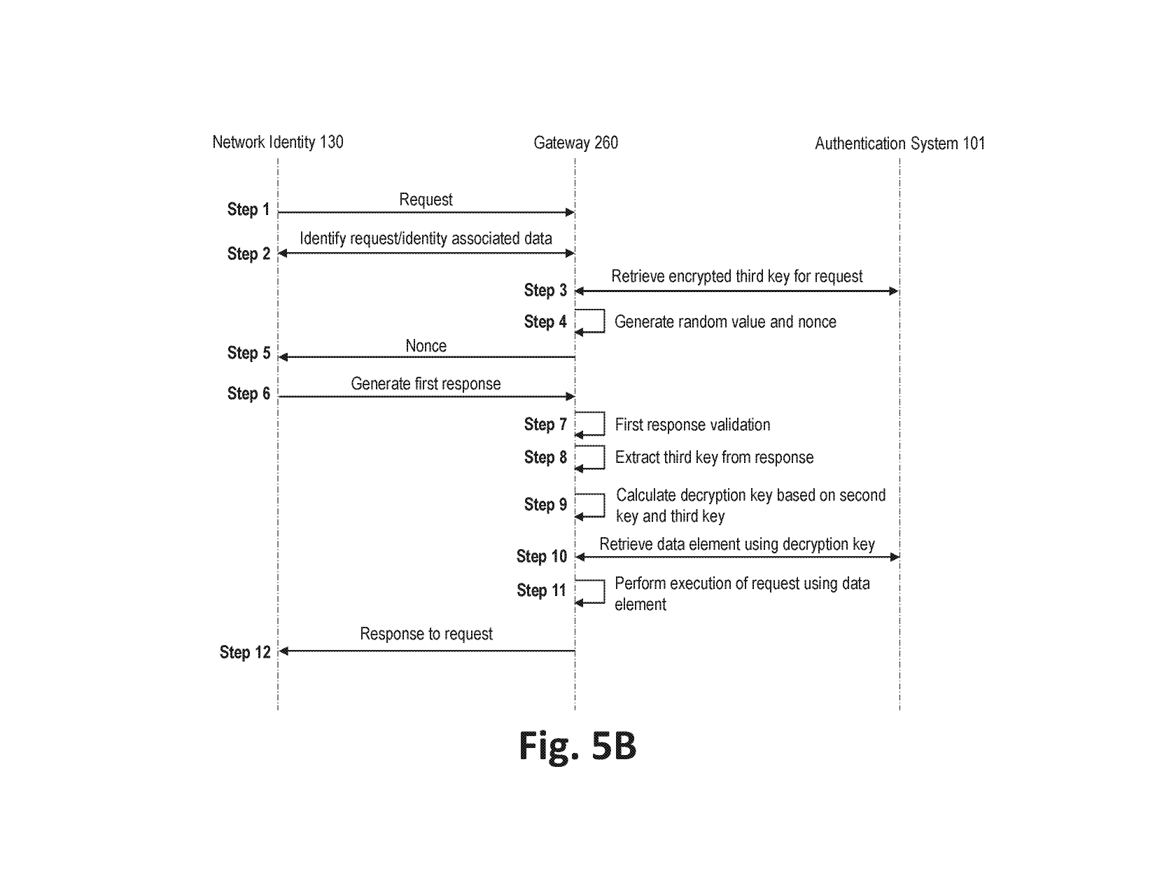

FIG. 1 is a block diagram showing an exemplary system 100 for performing actions automatically on network resources, according to some embodiments of the present disclosure. System 100 may include authentication system 101, which may include authentication engine 110 and repository 120 to help manage data required for performing actions on resource 140 as requested by network identity 130. Authentication engine 110 may generate and manage data needed for performing actions on resource 140. Repository 120 may include various data and identifiers to identify and access appropriate data needed to perform actions 124 on resource 140. In some embodiments, system 100 may include at least one gateway (e.g., gateway 260 described below with respect to FIGS. 5A and 5B) configured to act as a proxy to authentication system 101.

Authentication system 101 may perform actions immediately upon successful operations or after a period of time. For example, authentication system 101 may provide additional licensing information for an action to verify a license as part of authentication to access a resource (e.g., resource 140). In some embodiments, authentication system 101 may perform an action once or repeatedly when accessing a resource during a session. In some embodiments, authentication system 101 may allow the configuration of a time period for recurring actions at a fixed period, occurring at regular time intervals, or a dynamic period based on a trigger event. For example, authentication system 101 may be configured to perform an action dynamically when accessing certain resources or when a certain user or device is accessing a resource. Authentication system 101 may use repository 120 to store actions to perform and other configuration details for authentication engine 110 to perform the stored actions based on the parsed configuration details. Authentication system 101 utilizes authentication engine 110 and repository 120 to provide the ability to configure and store configured settings for performing actions repeatedly.

As illustrated in FIG. 1, authentication engine 110 may include data manager 111

and action performer 112 to manage data needed to perform actions and execute code related to actions. Repository 120 may include data elements 121 generated and encrypted by data manager 111 to perform actions. Repository 120 may also include data keys 122 to handle secure storage of data elements 121 and retrieval of decrypted data elements 121. Data keys 122 may include other keys as part of data keys 122 to encrypt some of data keys 122. Repository 120 may also include network identifiers 123 of various network identities, including network identity 130 associated with data elements 121. Repository 120 may also include actions 124, defining the type and time of execution of an action of actions 124 on behalf of a network identity (e.g., network identity 130) on a resource (e.g., resource 140).

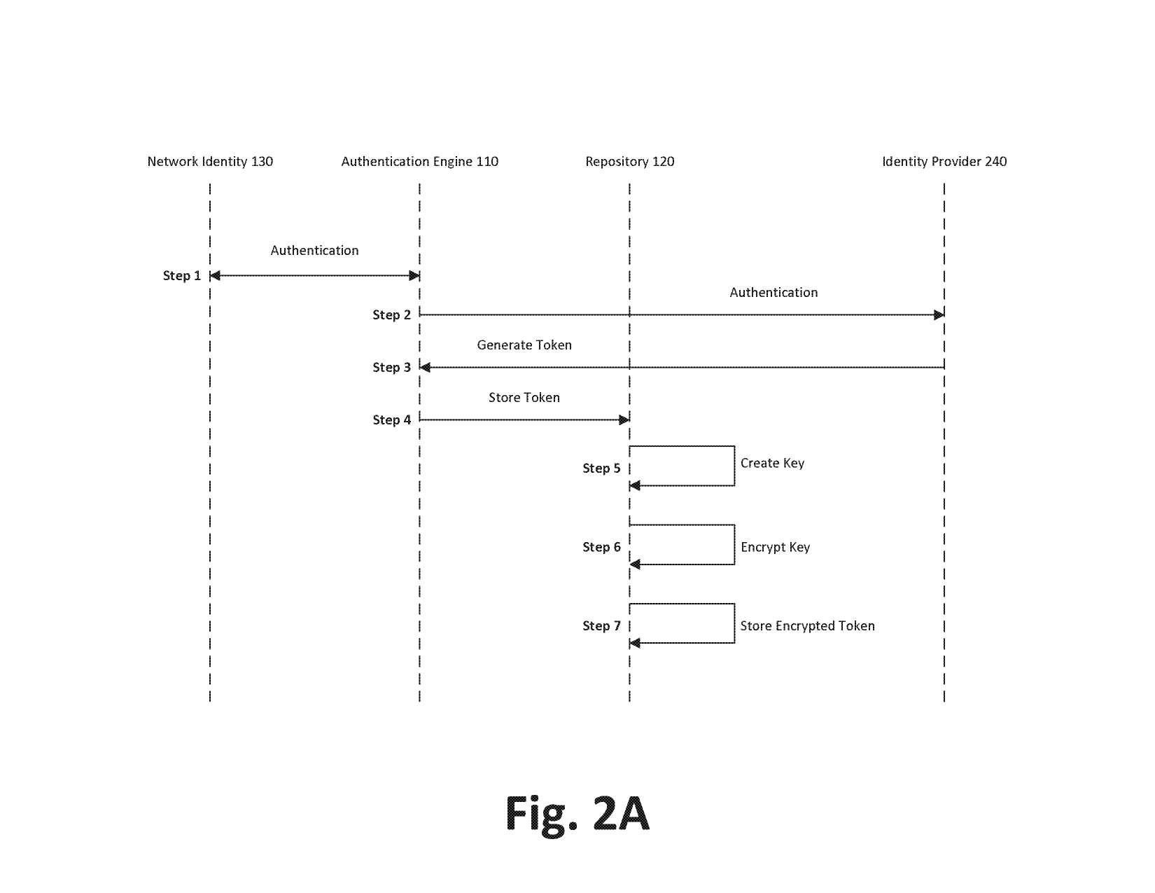

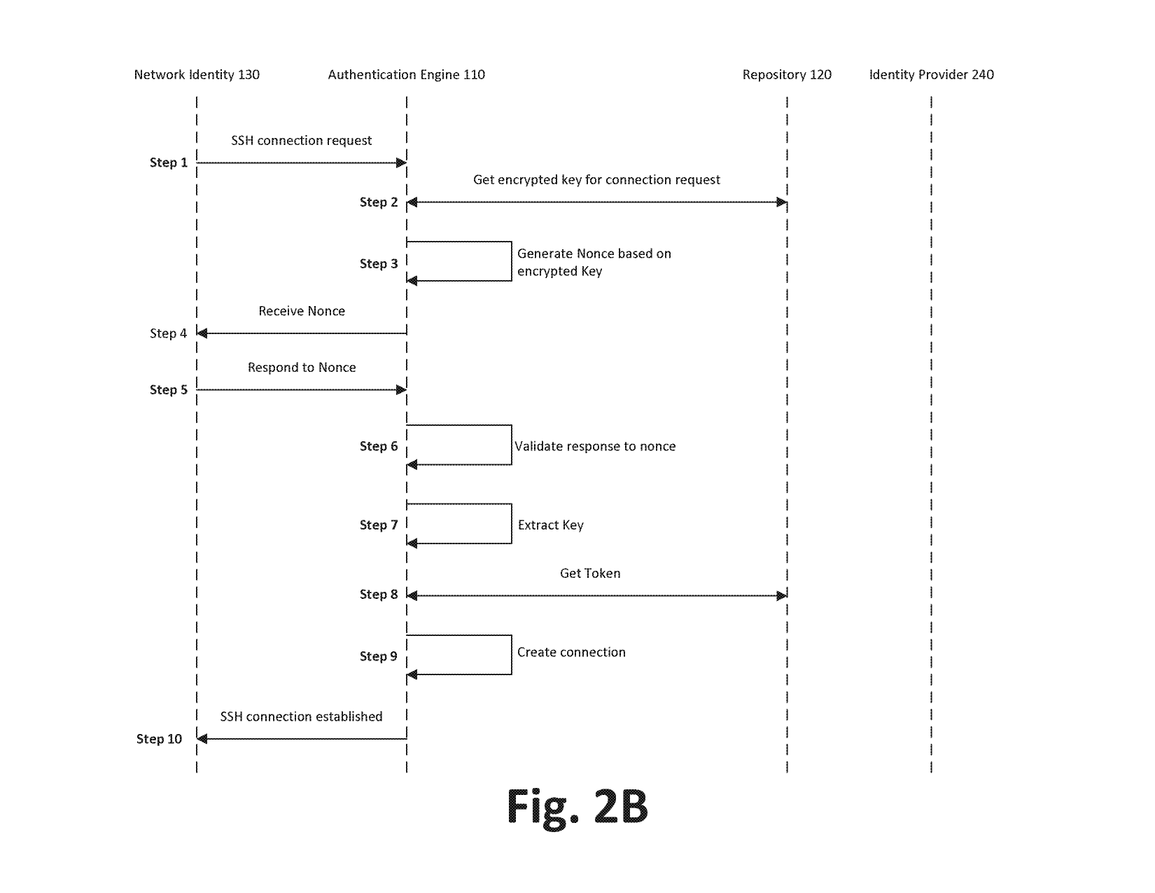

Authentication engine 110 may aid in the generation of data elements needed for performing actions 124 on resource 140. Network identity 130 may initiate the generation of data elements 121 by authenticating with authentication engine 110. Authentication engine 110 may receive data elements 121 required for performing actions 124 as part of data sent by network identity 130. In some embodiments, authentication engine 110 may request data elements (e.g., data elements 121) from a third party based on an authentication request transmitted by network identity 130. For example, network identity 130 may authenticate with authentication engine 110 and cause authentication engine 110 to generate a token for authenticating network identity 130 with various resources (e.g., resource 140). A detailed description of the generation of data elements is described in detail in connection with FIGS. 2A and 5A below.

Data manager 111 may manage data required for performing actions 124 on resource 140. Data managed by data manager 111 may include, for example, data input to actions 124, configurations of actions 124, or software code details to perform actions 124. Data manager 111 may receive data as part of the authentication of network identity 130 with authentication system 101.

Authentication of network identity 130 may include a user identity authentication on a device or device identity requesting a connection and access to resource 140. Network identity 130 may share data for performing an action as part of a communication protocol data packet transmitted between network identity 130 and authentication engine 110. For example, network identity 130 authenticating over secure shell (SSH) may share data relevant to performing actions in various fields present in data packets transmitted as part of a handshake to authenticate network identity 130 by authentication system 101. An example handshake of an SSH authentication using the Transmission Control Protocol (TCP) protocol with data related to actions is presented in detail in connection with FIGS. 2A-B below. In some embodiments, information transmitted by network identity 130 as part of an authentication may include details of the type of action and timing to perform the configured action.

Data manager 111 may retrieve information related to input data and configuration details of an action of actions 124 and stored in repository 120 as data elements 121. Data manager 111 may securely store input data in data elements 121 using encryption techniques. Data manager 111 may generate encryption keys (e.g., data keys 122) used to encrypt input data for actions transmitted by network identity 130 to store as data elements 121. In some embodiments, data manager 111 may receive encryption keys from a third-party service over network 150. Data manager 111 may store encrypted information related to input data and configuration details of an action as data elements 121. In some embodiments, data manager 111 may also encrypt keys used to encrypt data elements 121 and store them in data keys 122.

Data manager 111 may review data transmitted as part of a communication using existing communication and authentication protocols (e.g., SSH protocol, or others) and review various fields of data structures supplied as part of transmitted and received data. Data manager 111 may utilize software libraries associated with existing protocols. Data manager 111 may identify and retrieve different types of data from data transmitted by network identity to authentication system 101 at different times. For example, network identity 130 communicating with authentication system 101 using the SSH protocol may transmit different data to perform actions as part of the initial authentication request and later transmission of other commands. In some embodiments, data manager 111 may use data transmitted by network identity 130 to configure when and which fields to review to retrieve data in the future to perform requested actions. For example, network identity 130 may transmit configuration data related to an action of actions 124 to authentication system 101 as part of the initial handshake to authenticate network identity 130 and the actual data used to perform an action of actions 124 on resource 140 in later commands sent using the SSH protocol.

Action performer 112 may perform actions as requested by network identity 130. For example, action performer 112 may retrieve data keys of data keys 122 and data from data elements 121 to perform an action of actions 124. Action performer 112 may also, for example, refer to an index for retrieving relevant data keys of data keys 122, data elements of data elements 121, and actions 124. Of course, in other embodiments, action performer 112 may be coded and configured to perform other actions as well.

Action performer 112 may perform actions 124 on resource 140 based on the latest data at authentication system 101 from network identity 130 over network 150. In some embodiments, data transmitted from network identity 130 may include a mapping of data keys of data keys 122 to use with data elements of data elements 121 to decrypt and use them with an action of actions 124 to perform on resource 140. In some embodiments, data elements 121 may include configuration details to trigger action performer 112 to perform an action of actions 124. In some embodiments, data transmitted by network identity 130 may include a link to an action of actions 124 to perform on resource 140.

Action performer 112 may retrieve relevant data keys of data keys 122 to decrypt and access data elements of data elements 121 to use with an action of actions 124. In some embodiments, action performer 112 may receive a relevant decryption key to decrypt data elements of data elements 121 used to perform an action on resource 140. In some embodiments, a decryption key received as data from network identity 130 may decrypt an encrypted data key of data keys 122 to use to decrypt a data element of data elements 121.

Authentication engine 110 may utilize its components described above with various components of repository 120 to generate and manage resource 140 accessed by network identity 130. In various embodiments, repository 120 may take several different forms. For example, repository 120 may be an SQL database or NoSQL database, such as those developed by MICROSOFT™, REDIS, ORACLE™, CASSANDRA, MYSQL, or various other types of databases. According to such database techniques, data may be returned by calling a web service, by calling a computational function, from sensors, from IoT devices, or from various other data sources. Repository 120 may store data that is used or generated during the operation of applications, such as authentication engine 110 or its components. For example, if authentication engine 110 is configured to generate data to use to perform actions, such as data elements 121, repository 120 may store the generated data used to perform actions 124 in data elements 121, and encryption keys used to encrypt data elements 121 in data keys 122.

Similarly, if authentication engine 110 is configured to provide a previously generated or retrieved data element of data elements 121, authentication engine 110 may retrieve previously generated data keys (e.g., data keys 122) associated with data elements 121 in repository 120 to decrypt data elements 121. In some embodiments, repository 120 may be fed data from an external source, or the external source (e.g., server, database, sensors, IoT devices, etc.) may be a replacement. An external source may connect to repository 120 over a network (e.g., network 150).

Data elements 121 and data keys 122 may be provided by authentication engine 110 to store in repository 120. In some embodiments, data elements 121 and data keys 122 may be provided directly by a third-party software service or hardware. Repository 120 may maintain relationships between data elements 121 and data keys 122. The relations may describe which data key of data keys 122 may be used by authentication system 101 to encrypt and decrypt data elements 121 for secure storage of a data element. Data elements 121 and data keys 122 may be calculated using the data provided by network identity 130 in fields of data structures transmitted to authentication system 101 as part of communication packets of a chosen communication protocol. Authentication system 101 may manage data elements 121 to aid in a process of single sign-on of network identity 130 on different resources (e.g., resource 140), as described further herein.

Repository 120 may also include information about network identities (e.g., network identity 130) and resources (e.g., resource 140) that connect, perform, and track actions and share results of actions in network identifiers 123. Network identifiers 123 may include a hash map that may map between network identity 130 and the data keys 122 to identify the appropriate data key to decrypt a data element of data elements 121. In some embodiments, network identifiers 123 may map directly to data elements 121 to identify data elements of data elements 121 to use for performing actions of actions 124 on resource 140. In some embodiments, network identifiers 123 may also include mappings to actions 124 to determine which actions to perform on resource 140. Network identifiers 123 may map a network identifier to multiple data elements 121, data keys 122, and actions 124 using various data structures. Network identifiers 123 may map to a hierarchical data structure, such as JSON or other formats, to present relationships between various data elements of data elements 121 supplied to different actions of actions 124 to be performed on resource 140. For example, network identity 130 may require two different actions to log disk and network usage statistics on resource 140 and provide data elements 121 to define times to log disk and network usage statistics.

Repository 120 may also include descriptions of actions performed on resource 140 as actions 124. Authentication system 101 may access actions 124 to coordinate performance actions on resource 140 using data elements 121 identified by actions 124. Actions 124 may include files with configuration details of when to perform actions. For example, actions 124 configuration details may include what time intervals and what trigger events cause the performance of an action. Actions 124 may also include information about input data elements of data elements 121 and output file locations also represented by data elements 121.

Network identity 130 may be a network identity representing a human or a machine. In some embodiments, network identity 130 may be a human identity operating on a machine identity. A human identity may be represented by, for example, a user account on an operating system, a computing device, or an application. In some embodiments, a machine identity in the form of an application or service running on a computing instance or computing instance may be network identity 130. A list of various network identities utilizing authentication system 101 may be included in network identifiers 123. Network identity 130 may request access to resource 140 to perform actions 124 on resource 140.Actions 124 may include authentication of network identity 130 to access resource 140. Authentication system 101 may perform or facilitate single sign-on by network identity 130 to access various resources by using data elements 121. For example, authentication system 101 may supply tokens in data elements 121 for authenticating network identity 130 to access resource 140.

Resource 140 may be a software or hardware entity with the ability to connect and communicate with network identity 130. For example, resource 140 may be a software service accessible over network 150 to a user or a device represented by network identity 130. In some embodiments, resource 140 may be another network identity accessed by network identity 130.

Network 150 may take various forms. For example, the network 150 may include or utilize the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, or other types of network communications. In some embodiments, network 150 may include an on-premises (e.g., LAN) network, while in other embodiments, network 150 may include a virtualized (e.g., AWS™, Azure™, IBM Cloud™, etc.) network. Further, network 150 may in some embodiments, be a hybrid on-premises or fully virtualized network, including components of both types of network architecture.

FIGS. 2A-B are exemplary illustrations of the generation and usage of data elements 121 for establishing SSH connections, consistent with embodiments of the present disclosure. As illustrated in FIG. 2A, and performed by for example data manager 111, the process may help generate and store a token in data elements 121 to authenticate network identity 130 to connect with resource 140. Network identity 130 may request an SSH connection action, for instance, by authenticating with authentication system 101.

In step 1, network identity 130 authenticates with authentication engine 110 to help make a request to generate data elements (e.g., data elements 121 of FIG. 1) for performing actions (e.g., actions 124 of FIG. 1).

In step 2, authentication engine 110 may forward an authentication request from network identity 130 to a third-party identity provider 240 to help generate data elements. Authentication engine 110 may forward the complete authentication request received in step 1 or partial information identifying network identity 130, such as IP address, MAC address, or user account name, etc.

In step 3, identity provider 240 may transmit a token as a data element to authentication engine 110 to associate with network identity 130. In some embodiments, identity provider 240 may generate and transmit a new token as a data element of data elements 121 for every request from network identity 130.

In step 4, authentication engine 110 may request repository 120 to store the token received in step 3 in data elements 121. Data manager 111 of authentication engine 110 may make a request for storing the token.

In step 5, repository 120 may secure (e.g., encrypt) the received data element using data keys 122. Repository 120 may generate a key to use with the token from step 3. Repository 120 may store the generated key in data keys 122 (as shown in FIG. 1).

In step 6, repository 120 may encrypt the key generated in step 5 using a public key related to network identity 130. Authentication system 101 may generate public key related to network identity 130.

In step 7, repository 120 may encrypt the token using the key from step 5 and store the encrypted token in data elements 121. Repository 120 may store the encrypted key from step

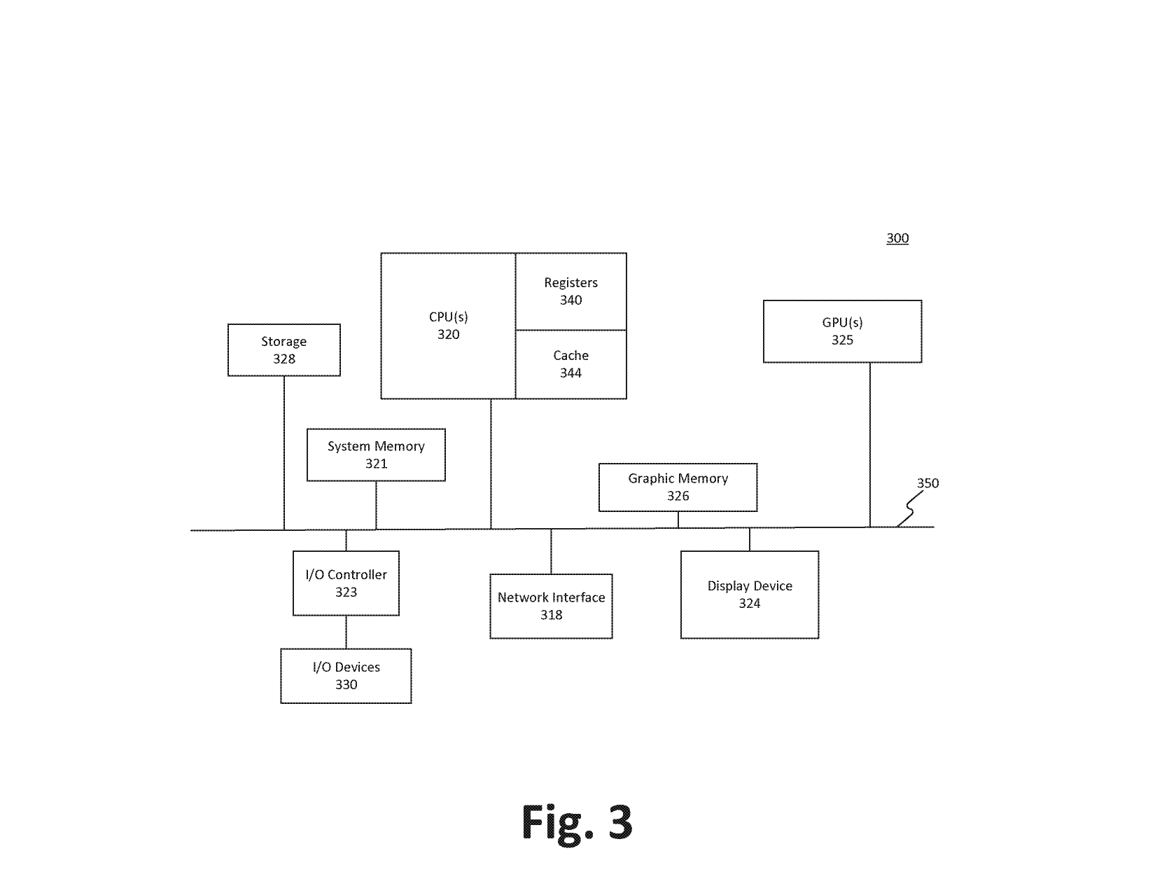

6 in data keys 122. Repository 120 may also create a mapping between an identifier of the token from step 3 and the encrypted token, and store it in data elements 121. In some embodiments, repository 120 may also create a mapping between an identifier of the token and the encrypted key from step 6, and store it in data keys 122. A token identifier may include an identifier of the network identity 130, such as IP address of an operating system, MAC address of network interface (e.g., Network interface 318 of FIG. 3), or user account representing network identity 130, etc. Authentication system 101 may use stored tokens as data elements 121 and encrypted keys as data keys 122 to perform actions. A detailed description of the use of tokens in data elements 121 to perform actions (e.g., actions 124 of FIG. 1) on resource 140 is provided in connection with FIG. 2B below.

FIG. 2B shows an exemplary usage of data elements, according to some embodiments of the present disclosure. As illustrated in FIG. 2B, authentication engine 110 may use previously generated tokens and keys to perform actions (e.g., actions 124 of FIG. 1) on resource 140.

In step 1, network identity 130 may send an SSH connection request as an action to authentication engine 110 to connect with resource 140 (as shown in FIG. 1). In some embodiments, additional actions to perform on resource 140 may be included in the SSH connection request sent by network identity 130. For example, the SSH connection request may include logging actions for network usage and disk usage, among other potential actions.

In step 2, authentication engine 110 may retrieve the encrypted key in data keys 122 (as shown in FIG. 1) from repository 120 generated as per the steps described in connection with FIG. 2A above.

In steps 3-7, authentication engine 110 may confirm network identity 130 before retrieving the relevant key in data keys 122 (as shown in FIG. 1) to decrypt the token in data elements 121 (as shown in FIG. 1) to establish the requested SSH connection from step 1. In step 3, the process may prepare a nonce to validate network identity 130 before extracting the stored token in data elements 121. Authentication engine 110 may generate the nonce by generating a random number and providing it as an input parameter along with the encrypted key from step 2 and the public key of network identity 130 to a nonce generation library function.

In step 4, authentication engine 110 may transmit the nonce from step 3 to network identity 130 over a standard communication protocol, such as SSH, Remote Desktop Protocol (RDP), etc.

In step 5, network identity 130 may decrypt the nonce using a private key related to the public key in step 3. Network identity 130 may transmit the decrypted nonce to authentication engine 110.

In step 6, authentication engine 110 may validate the response from step 5 by comparing it to the nonce generated in step 3.

In step 7, authentication engine 110 may retrieve the key from the encrypted key of step 2 using the nonce from step 5. The response nonce from step 5 may include the decryption key needed to decrypt the key encrypted using the public key. By limiting access to the key to only through a response to nonce generated by network identity 130, authentication engine 110 of authentication system 101 needs network identity 130 to establish a connection and cannot impersonate an identity on its own. Such a setup avoids a single point of failure and the risk of impersonating any user with access to tokens representing various network identities. Authentication system 101 may generate nonce for which network identity 130 may generate a response.

In step 8, authentication engine 110 retrieves the token in data elements 121 by looking based on network identity 130 and decrypting using the key from step 7.

In step 9, authentication engine 110 may use the token to generate an SSH connection. Authentication engine 110 may generate the SSH connection to resource 140. The SSH connection may include an action requested by network identity 130 to perform on resource 140.

In step 9, network identity 130 may receive a confirmation of an established SSH connection based on the connection request in step 1. Network identity 130 may then be able to conduct actions such as sign sign-on by sharing data needed to set up connections using tokens and validating keys used to retrieve tokens.

FIG. 3 is a block diagram of an exemplary computing device 300, consistent with embodiments of the present disclosure. In some embodiments, computing device 300 may be a specialized server or other computing resource providing the functionality described herein. In some embodiments, components of authentication system 101, such as authentication engine 110 and repository 120 of FIG. 1, may be implemented using the computing device 300 or multiple computing devices 300 operating in parallel. Further, the computing device 300 may be a second device providing the functionality described herein or receiving information from a server to provide at least some of the described functionality. Moreover, the computing device 300 may be an additional device or devices that store or provide data consistent with embodiments of the present disclosure and, in some embodiments, computing device 300 may be a virtualized computing device such as a virtual machine, multiple virtual machines, or a hypervisor.

Computing device 300 may include one or more central processing units (CPUs) 320 and a system memory 321. Computing device 300 may also include one or more graphics processing units (GPUs) 325 and graphic memory 326. In some embodiments, computing device 300 may be a headless computing device that does not include GPU(s) 325 or graphic memory 326.

CPUs 320 may be single or multiple microprocessors, field-programmable gate arrays, or digital signal processors capable of executing sets of instructions stored in a memory (e.g., system memory 321), a cache (e.g., cache 341), or a register (e.g., one of registers 340). CPUs 320 may contain one or more registers (e.g., registers 340) for storing various types of data including, inter alia, data, instructions, floating-point values, conditional values, memory addresses for locations in memory (e.g., system memory 321 or graphic memory 326), pointers and counters. CPU registers 340 may include special-purpose registers used to store data associated with executing instructions such as an instruction pointer, an instruction counter, or a memory stack pointer. System memory 321 may include a tangible or a non-transitory computer-readable medium, such as a flexible disk, a hard disk, a compact disk read-only memory (CD-ROM), magneto-optical (MO) drive, digital versatile disk random-access memory (DVD-RAM), a solid-state disk (SSD), a flash drive or flash memory, processor cache, memory register, or a semiconductor memory. System memory 321 may be one or more memory chips capable of storing data and allowing direct access by CPUs 320. System memory 321 may be any type of random-access memory (RAM), or other available memory chip capable of operating as described herein.

CPUs 320 may communicate with system memory 321 via a system interface 350, sometimes referred to as a bus. In embodiments CPUs 320 may include GPUs 325, and GPUs 325 may be any type of specialized circuitry that may manipulate and alter memory (e.g., graphic memory 326) to provide or accelerate the creation of images. GPUs 325 may have a highly parallel structure optimized for processing large, parallel blocks of graphical data more efficiently than general-purpose CPUs 320. Furthermore, the functionality of GPUs 325 may be included in a chipset of a special purpose processing unit or a co-processor.

CPUs 320 may execute programming instructions stored in system memory 321 or other memory, operate on data stored in memory (e.g., system memory 321), and communicate with GPUs 325 through the system interface 350, which bridges communication between the various components of the computing device 300. In some embodiments, CPUs 320, GPUs 325, system interface 350, or any combination thereof, may be integrated into a single chipset or processing unit. GPUs 325 may execute sets of instructions stored in memory (e.g., system memory 321), to manipulate graphical data stored in system memory 321 or graphic memory 326. For example, CPUs 320 may provide instructions to GPUs 325, and GPUs 325 may process the instructions to render graphics data stored in the graphic memory 326. Graphic memory 326 may be any memory space accessible by GPUs 325, including local memory, system memory, on-chip memories, and hard disk. GPUs 325 may enable displaying of graphical data stored in graphic memory 326 on display device 324 or may process graphical information and provide that information to connected devices through network interface 318 or I/O devices 330.

Computing device 300 may include a display device 324 and input/output (I/O) devices 330 (e.g., a keyboard, a mouse, or a pointing device) connected to I/O controller 323. I/O controller 323 may communicate with the other components of computing device 300 via system interface 350. It should now be appreciated that CPUs 320 may also communicate with system memory 321 and other devices in manners other than through system interface 350, such as through serial communication or direct point-to-point communication. Similarly, GPUs 325 may communicate with graphic memory 326 and other devices in ways other than system interface 350.

In addition to receiving input, CPUs 320 may provide output via I/O devices 330 (e.g., through a printer, speakers, bone conduction, or other output devices).

Furthermore, the computing device 300 may include a network interface 318 to interface to a LAN, WAN, MAN, or the Internet through a variety of connections including, but not limited to, standard telephone lines, LAN or WAN links (e.g., 802.21, T1, T3, 56 kb, X.25), broadband connections (e.g., ISDN, Frame Relay, ATM), wireless connections (e.g., those conforming to, among others, the 802.11a, 802.11b, 802.11b/g/n, 802.11ac, Bluetooth, Bluetooth LTE, 3GPP, or WiMax standards), or some combination of any or all of the above. Network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

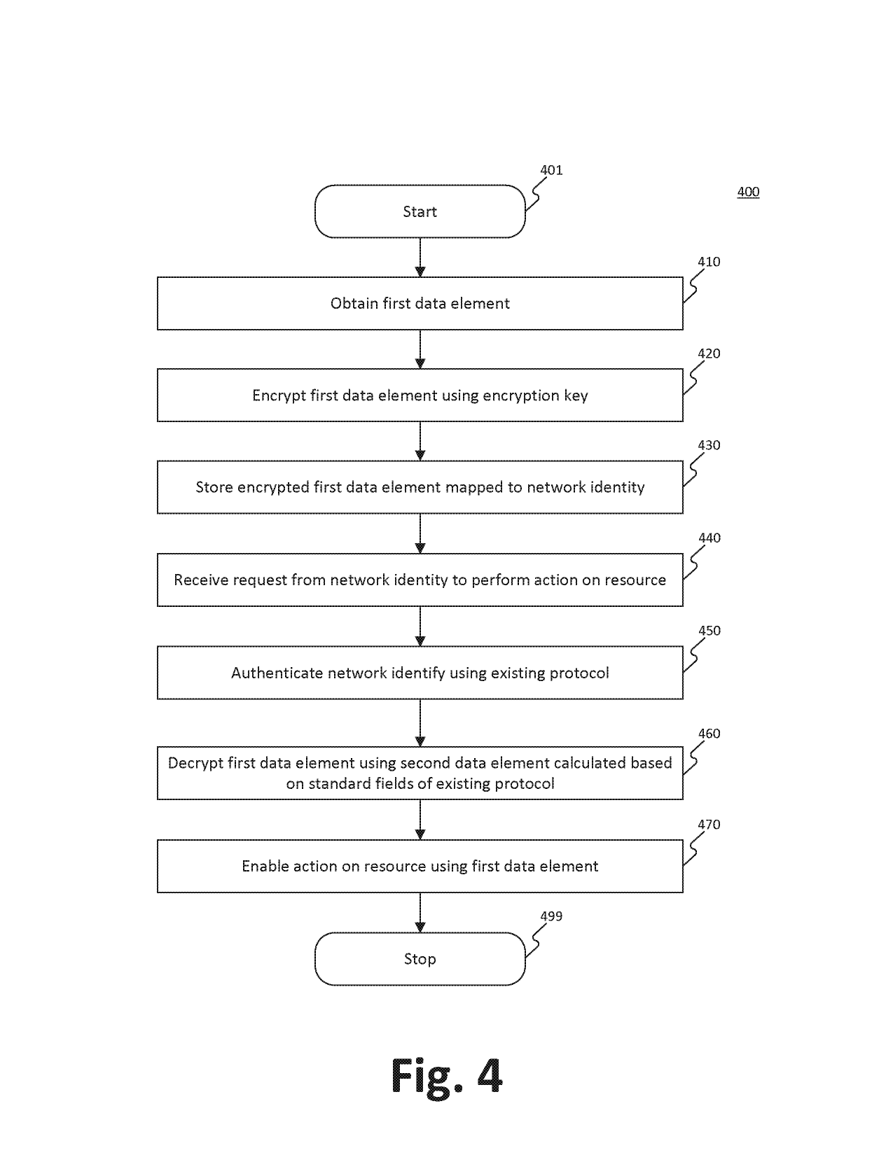

FIG. 4 is a flowchart depicting operations of an exemplary method 400 when using network identity 130, according to some embodiments of present disclosure. The steps of method 400 may be performed by, for example, authentication system 101 of FIG. 1 executing on or otherwise using the features of computing device 300 of FIG. 3 for purposes of illustration. It will be appreciated that the exemplary method 400 may be altered to modify the order of steps and to include additional steps.

Process 400 may begin in a step 401. Step 401 may occur on demand, periodically, or as needed based on requests to access secure network resources. In step 410, authentication system 101 may obtain the first data element. The first data element may include a token, a secret, a text, or a file. For example, the first data element may be a token generated in step 3 of FIG. 2A described above to aid in establishing SSH connections on behalf of network identity 130 (as

shown in FIG. 1). In some embodiments, the first data element may be a text element representing a path to a file. The file may include a script to be executed on resource 140 (as shown in FIG. 1) or retrieve and transform data from resource 140. In some embodiments, network identity 130 may offer the first data element of data elements 121 (as shown in FIG. 1).

Authentication system 101 may obtain the first data element from network identity 130 when network identity 130 provides authentication information. For example, authentication engine 110 of authentication system 101 obtains a token from identity provider 240 (as shown in FIG. 2A) upon receiving an authentication request as described in FIG. 2A description above. Authentication system 101 may review data packets received over network 150 (as shown in FIG. 1) to retrieve the first data element. Authentication system 101 may retrieve the first data element from standard fields of an existing protocol (e.g., SSH, RDP, etc.) used for communication by network identity 130 for authentication with authentication system 101.

In step 420, authentication system 101 may encrypt the first data element using a key. Authentication system 101 may encrypt the first data element using the data key obtained from a database (e.g., data keys 122 in repository 120 of FIG. 1) and then encrypt the data key using another encryption key. For example, the data key may be encrypted using a public key associated with network identity 130, as described in step 6 of FIG. 2A description above. Authentication system 101 may then map the encrypted first data element and the encrypted data key to network identity 130 and store the mapping in repository 120.

In step 430, authentication system 101 may store the encrypted first data element mapped to network identity 130 in repository 120. In some embodiments, authentication system 101 may store the encrypted data key from step 420 along with the encrypted first data element in data keys 122 and data elements 121. In some embodiments, the encrypted data element and the

encrypted data key may be stored in a resource (e.g., resource 140 of FIG. 1) where data element contents may be utilized. For example, an encrypted data element used for logging activity on resource 140 may be stored in resource 140. In some embodiments, authentication system 101 may store the encrypted first data element in another resource other than repository 120.

In step 440, authentication system 101 may receive a request from network identity 130 to perform an action (e.g., actions 124 of FIG. 1) on resource 140. In some embodiments, authentication system 101 may determine an action based on the first data element received in step 410. For example, network identity 130 may transmit a data element (of data elements 121) with a description of an action, such as a path to a code to execute on resource 140. In some embodiments, authentication system 101 may receive an authentication request from network identity to authenticate with resource 140 that may include a request to perform an action on resource 140. In some embodiments, authentication system 101 may receive an action request by retrieving action of actions 124 (as shown in FIG. 1) upon receiving an authentication request. In some embodiments, network identity 130 may include the name of an action to perform on resource 140 in a field of a data structure transmitted as part of a communication protocol used by network identity 130 to communicate with authentication system 101.

In step 450, authentication system 101 may authenticate network identity 130 using existing communication protocols. Existing protocols may be one of, for instance,

RDP, SSH, Password Authentication Protocol (PAP), Challenge Handshake Authentication Protocol (CHAP), Extensible Authentication Protocol (EAP), AKA, Basic Access Authentication, CAVE-based Authentication, CRAM-MD5, Digest, Host Identity Protocol (HIP), NTLM, Kerberos, OpenID, Radius, SMAL, OAuth2, LDAP, SRP, RFID-Authentication Protocols, Woo Lam 92, HyperText Transfer Protocol Secure (HTTPS), or Transport Layer Security (TLS), etc. Authentication system 101 executing on computing device 300 may have preinstalled libraries related to existing communication protocols

In step 460, authentication system 101 may decrypt the first data element using the second data element calculated based on the standard fields of an existing protocol. For example, the second data element may be the nonce generated in step 3 of FIG. 2B to validate the identity of network identity 130 requesting to perform an action.

The standard fields may be attributes included in packages used by an existing protocol. In some embodiments, the standard fields may be included as part of an extension of an existing protocol. The number of standard fields may vary depending on the type of protocol chosen for communication by network identity 130. In some embodiments, the standard fields may include a value used by an existing protocol as part of communication content. For example, the standard fields may include a nonce used as a response to nonce by an existing protocol. In some embodiments, the standard fields may include values used to represent attributes of network identity 130. For example, an existing protocol such as RDP may include a license of network identity 130 in the standard fields. The standard fields used by network identity 130 may not affect the performance or security of an existing protocol.

In some embodiments, network identity 130 may authenticate with authentication system 101 using multi-factor authentication, and the standard fields may include one or more factors of multi-factor authentication In some embodiments, authentication system 101 may decrypt the first data element immediately as part of authentication in step 450. In some embodiments, authentication system 101 may wait for a trigger event post-authentication to decrypt the first data element. Authentication system 101 may decrypt the first data element multiple times for each trigger event. Trigger events may be automatic such as a set time period, or may be configured using a configuration setting provided as input along with the first data element and stored as data elements 121.

Network identity 130 requesting decryption of the first data element may not generate it on its own and may require it to be supplied by authentication system 101. Network identity 130 may calculate the second data element using the first data element. In some embodiments, network identity 130 may request resource 140 to help calculate the second data element. The second data element may be a decrypted version of the first data element used as input to perform an action on resource 140. For example, the second data element may be a token to authenticate network identity 130 to have a SSH connection with resource 140 without providing any details directly to resource 140.

In step 470, authentication system 101 may enable the action on resource 140 using the first data element. In some embodiments, authentication system 101 may determine the action of actions 124 using the first data element prior to enabling the action on resource 140. Authentication system 101, upon completion of step 470, completes (step 499) executing method 400.

FIGS. 5A and 5B are exemplary illustrations of the generation and usage of data elements 121 for establishing secure connections, consistent with embodiments of the present disclosure. As illustrated in FIG. 5A, and performed by at least one processor (e.g., of data manager 111, authentication engine 110, authentication system 101, repository 120, identity provider 240, or gateway 260), the process may help store an encrypted secret associated with network identity 130 in data elements 121 for later retrieval and decryption to perform a requested action on resource 140 using the secret. Additionally or alternatively, the steps of FIGS. 5A and 5B may be performed in a distributed environment with multiple repositories.

In step 1, authentication system 101 may receive at least one data element (e.g., secret, token, key, passcode, certificate, multi-factor authentication token, delegated access credential or any combination of two or more of the above) associated with a network identity 130 from at least one of identity provider 240 or a gateway 260 for storage in repository 120. In some embodiments, gateway 260 may be integrated with authentication system 101. In some embodiments, gateway 260 may be external to, but interactive with authentication system 101.

In step 2, authentication system 101 may create a first key. For example, the first key may comprise a base key. In some embodiments, authentication system 101 may create (e.g., generate) the first key using a cryptographic algorithm (e.g., Advanced Encryption Standard with a 256-bit key (AES-256), Rivest-Shamir-Adleman (RSA)) with high-entropy randomness. Additionally or alternatively, authentication system 101 may create the first key using protocol-specific fields or device identifiers. Additionally or alternatively, a hardware security module of authentication system 101 may generate the first key to enhance entropy and tamper resistance. In some embodiments, the first key may be derived using a key-derivation function from a seed value generated using multiple entropy sources, or bound to contextual parameters. In some embodiments the first key may be generated within a secure enclave or trusted execution environment. For example, attestation may be required to verify an integrity of the generating entity. In some embodiments, lifecycle policies such as key rotation, expiration, or versioning may be implemented when the first key is created.

In step 3, authentication system 101 may create a second key. For example, the second key may comprise a gateway key associated with gateway 260. In some embodiments, authentication system 101 may generate the gateway key during deployment of gateway 260 using a secure initialization protocol. Additionally or alternatively, the gateway key may be periodically rotated to comply with key lifecycle management policies.

In step 4, authentication system 101 may create a third key. For example, the third key may comprise an identity key created based on the first key and the second key. In some embodiments, authentication system 101 may generate the third key by combining the first key and the second key using a reversible cryptographic operation (e.g., XOR). Additionally or alternatively, authentication system 101 may combine the first key and the second key using modular addition or a key derivation function (KDF). Additionally or alternatively, authentication system 101 may split the third key into multiple shares using Shamir secret sharing.

In step 5, authentication system 101 may encrypt the third key using a public key associated with the network identity 130. In some embodiments, the public key may be part of a key pair (e.g., public key and private key pair) created on authentication of network identity 130 (e.g., at least one of step 1 or step 2 of FIG. 2A). In some embodiments, authentication system 101 may encrypt the third key using RSA or elliptic curve cryptography. Additionally or alternatively, authentication system 101 may encrypt the third key by performing hybrid encryption combining asymmetric and symmetric techniques for increased security.

In step 6, authentication system 101 may store the encrypted third key in repository 120. In some embodiments, authentication system 101 may additionally store metadata associated with network identity 130, including identifiers such as a user ID, device ID, or allowed access or usage contexts. In some embodiments, metadata may include protocol negotiation parameters or geolocation constraints. Additionally or alternatively, authentication system 101 may store policy attributes for dynamic data element selection.

In step 7, gateway 260 may receive the second key from authentication system 101 . For example, gateway 260 may receive the second key from authentication system 101 for storage in gateway 260. Additionally or alternatively, gateway 260 may receive the second key from authentication system 101 for storage in another component (e.g., internal or external to gateway 260) associated with gateway 260. In some embodiments, gateway 260 may additionally receive a confirmation from authentication system 101 that the third key was encrypted and securely stored. In some embodiments, gateway 260 may maintain an audit log of key generation and storage events for compliance.

FIG. 5B shows an exemplary usage of data elements, according to some embodiments of the present disclosure. As illustrated in FIG. 5B, gateway 260 may use previously generated data elements to perform actions (e.g., actions 124 of FIG. 1) on resource 140 without exposing the data elements to network identity 130 or any entity associated with network identity 130. In some embodiments, gateway 260 may interact with network identity 130 or an entity associated with network identity 130 (e.g., requestor) and authentication system 101 to validate an identity of the requestor and retrieve the encrypted key.

In step 1, gateway 260 may receive a request from network identity 130 or an entity associated with network identity 130 (e.g., requestor) to perform at least one action requiring access to at least one resource. In some embodiments, the request may include attributes or protocol-specific fields. For example, the request may include contextual attributes or protocol negotiation fields such as a username, type of authentication, role, client type, selected cipher suite, nonce, internet protocol (IP) address, media access control (MAC) address, license, type of native communication protocol, selected cipher suite, location, network provider, device identifier, requested resource, request time, or secure zone information. In some embodiments, the request may include SSH session initiation. Additionally or alternatively, the request may include TLS handshake parameters or Application Programming Interface (API) access tokens.

In step 2, gateway 260 may identify the request and associated identity data (e.g., identified data) to locate at least one relevant encrypted third key (e.g., encrypted data element). For example, gateway 260 may use a context-matching engine to examine attributes included in the request and identify one or more candidate encrypted data elements mapped to the identity. Additionally or alternatively, gateway 260 may utilize machine learning models trained to predict the correct or most relevant encrypted data element based on historical data (e.g., historical usage patterns). Additionally or alternatively, gateway 260 may utilize machine learning models trained to predict the correct or most relevant encrypted data element based on the identified data (e.g., contextual attributes or protocol negotiation fields) included in the request.

In step 3, gateway 260 may retrieve the at least one relevant encrypted third key (e.g., from step 6 of FIG. 5A) from authentication system 101 (e.g., repository 120). For example, gateway 260 may retrieve the at least one relevant encrypted data element from repository 120 corresponding to network identity 130. In some embodiments, gateway 260 may also retrieve associated metadata for validation.

In step 4, gateway 260 may generate a random value and nonce to initiate a challenge-response protocol for identity validation. In some embodiments, the nonce may be combined with protocol negotiation fields for additional entropy. Additionally or alternatively, gateway 260 may use a time-based nonce to prevent replay attacks. In some embodiments, gateway 260 may generate the random value and nonce using a cryptographically secure random number generator (CSPRNG) to ensure unpredictability. Additionally or alternatively, gateway 260 may use monotonic counters, sequence numbers, or per-session identifiers to ensure that each nonce is unique within a given context. Additionally or alternatively, gateway 260 may bind the nonce to session parameters. For example, the nonce may be combined with session-specific attributes (e.g., session ID, client ID, or TLS channel bindings) to prevent cross-protocol or cross-session replay. In some embodiments, the nonce may be a predefined bit-length (e.g., 128-big or 256-bit) or encoding format (e.g., base64, hex) determined based on protocol requirements. In some embodiments, gateway 260 may use a hardware security module or trusted execution environment to generate the nonce. Additionally or alternatively, gateway 260 may implement expiration policies for the nonce to limit a time in which a replay attach could occur.

In step 5, network identity 130 may process the nonce using a private key (e.g., of the key pair) and, in step 6, may generate a first response. In some embodiments, the first response may include a digital signature over the nonce. Additionally or alternatively, the response may include a hash-based message authentication code (HMAC) for integrity verification.

In step 7, gateway 260 may validate the first response by verifying the signature and matching the nonce. In some embodiments, gateway 260 may check session attributes against stored metadata. Additionally or alternatively, gateway 260 may perform multi-factor validation. For example, gateway 260 may perform validation using device fingerprints.

In step 8, gateway 260 may extract the third key from the encrypted data using the validated response and, in step 9, may calculate a decryption key based on the second key and the third key. For example, gateway 260 may generate the decryption key by combining the second key and the third key. In some embodiments, generating the decryption key may comprise using modular addition or KDF. Additionally or alternatively, gateway 260 may require multiple shares to reconstruct the decryption key when Shamir secret sharing is applied.

In step 10, gateway 260 may use the decryption key to retrieve and decrypt the data element from repository 120. In some embodiments, decryption may comprise using AES, AES-GCM, AES-XTS, Twofish, or ChaCha20. Additionally or alternatively, gateway 260 may apply hardware acceleration for cryptographic operations to execute the cryptographic operations more quickly and securely. In some embodiments, gateway 260 may use an asymmetric key (e.g., RSA or ECC) to unwrap or decrypt a session key, which may be used for bulk decryption. Additionally or alternatively, gateway 260 may decrypt large data elements in streaming mode to reduce memory usage. Additionally or alternatively, gateway 260 may use an authenticated encryption mode (e.g., AES-GCM, ChaCha20-Poly1305) to improve security. In some embodiments, gateway 260 may decrypt the data element in a trusted execution environment to prevent exposure of sensitive data (e.g., keys). In some embodiments, gateway 260 may verify that the requestor has permission to use the decryption key. Additionally or alternatively, gateway 260 may validate at least one message authentication codes (MAC) or digital signature as part of the decryption process.

In step 11, gateway 260 may use the data element to fulfill the requested action securely. In some embodiments, gateway 260 may establish an SSH session or may complete a TLS handshake. Additionally or alternatively, gateway 260 may use the data element to generate temporary credentials for resource access.

In step 12, gateway 260 may send a response to the requestor confirming successful completion of the action associated with resource 140. In some embodiments, gateway 260 may transmit, to the requestor, a proof of execution for compliance verification.

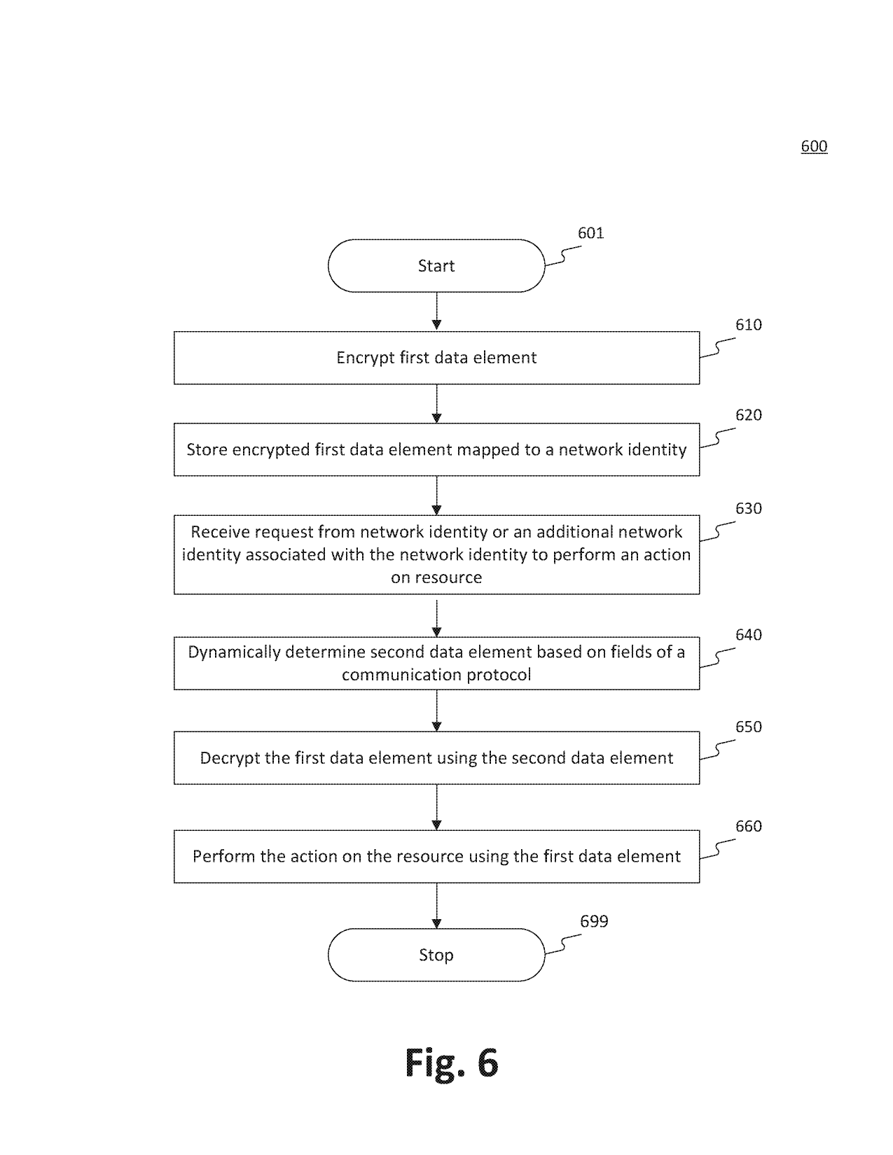

FIG. 6 is a flowchart depicting operations of an exemplary method 600 associated with network identity 130, according to some embodiments of present disclosure. The steps of method 600 may be performed by at least one processor (e.g., of system 100, data manager 111, authentication engine 110, authentication system 101, repository 120, identity provider 240, or gateway 260), executing on or otherwise using the features of computing device 300 of FIG. 3 for purposes of illustration. It will be appreciated that the exemplary method 600 may be altered to modify the order of steps and to include additional steps.

Process 600 may begin in a step 601. Step 601 may occur on demand, periodically, or as needed based on requests to access secure network resources. In step 610, system 100 may encrypt a first data element. The first data element may include a token, a secret, a text, or a file. For example, the first data element may be a secret obtained from or generated by identity provider 240 or gateway 260 in step 1 of FIG. 5A described above. In some embodiments, the first data element may be a text element representing a path to a file. The file may include a script to be executed on resource 140 (as shown in FIG. 1) or retrieve and transform data from resource 140. System 100 may encrypt the first data element using various encryption techniques. For example, system 100 may use symmetric encryption algorithms such as AES-256 or asymmetric encryption algorithms like RSA.

In some embodiments, system 100 may encrypt the first data element using a key. For example, system 100 may create a plurality of keys. In some embodiments, system 100 may create a first key and a second key, and then may create a third key based on the first key and the second key. For example, the first data element may be encrypted using the third key of step 5 of FIG. 5A described above.

In some embodiments, system 100 may obtain a plurality of first data elements and may encrypt the plurality of first data elements. For example, system 100 may obtain different types of first data elements such as tokens, secrets, texts, or files for various access scenarios. System 100 may encrypt each first data element using distinct encryption keys or algorithms. Additionally or alternatively, system 100 may associate metadata with each encrypted first data element, describing its intended use, access level, or applicable context.

In step 620, system 100 may store the encrypted first data element mapped to a network identity. System 100 may store the encrypted first data element in repository 120 as described in step 6 of FIG. 5A above. In some embodiments, system 100 may store multiple encrypted data elements for a single network identity, each associated with different contexts or access levels. Additionally or alternatively, system 100 may store the encrypted first data element in a distributed manner across multiple repositories for enhanced security and availability. In some embodiments, system 100 may store the plurality of encrypted first data elements, wherein each encrypted first data element of the plurality of encrypted first data elements is mapped to the network identity. Additionally or alternatively, each encrypted first data element of the plurality of encrypted first data elements may be stored with metadata about the encrypted first data element. For example, the metadata may describe characteristics or intended use associated with the first data element, may include information about a type of resource the first data element is associated with, a level of access it grants, or conditions under which the first data element should be used.

In step 630, system 100 may receive a request from the network identity or an additional network identity associated with the network identity to perform an action (e.g., actions 124 of FIG. 1) on a resource (e.g., resource 140) as described in step 1 of FIG. 5B above. In some embodiments, the request may include various attributes such as username, role, client type, selected cipher suite, nonce, IP address, device identifier, requested resource, request time, and secure zone. Gateway 260 may process these attributes to determine the appropriate context for the request.

In some embodiments, system 100 may authenticate network identity 130 using existing protocol as described in step 450 of FIG. 4 above. For example, gateway 260 may authenticate network identity 130 using existing communication protocols. Existing protocols may be one of, for instance, RDP, SSH, Password Authentication Protocol (PAP), Challenge Handshake Authentication Protocol (CHAP), Extensible Authentication Protocol (EAP), AKA, Basic Access Authentication, CAVE-based Authentication, CRAM-MD5, Digest, Host Identity Protocol (HIP), NTLM, Kerberos, OpenID, Radius, SMAL, OAuth2, LDAP, SRP, RFID-Authentication Protocols, Woo Lam 92, HTTPS, or TLS, etc. System 100 executing on computing device 300 may have preinstalled libraries related to existing communication protocols.

In some embodiments, system 100 may identify data associated with at least one of the network identity, additional network identity, or the request as described in step 2 of FIG. 5B above. For example, identified data may include at least one of a username of the network identity or the additional network identity, a group the network identity or the additional network identity is associated with, a role the network identity or the additional network identity is associated with, a type of authentication used for the network identity or the additional network identity, an internet protocol (IP) address associated with the network identity or the additional network identity, a type of client associated with the network identity or the additional network identity, a location of the network identity or the additional network identity, a network provider for the network identity or the additional network identity, a license associated with the network identity or the additional network identity, a type of native communication protocol, a selected cipher suite, the resource associated with the request, metadata associated with the resource associated with the request, the action associated with the request, the communication protocol, secure zone information, a time of the request, or a device identifier. In some embodiments, system 100 may identify relevant standard fields of the communication protocol based on the identified data.

In some embodiments, system 100 may identify and retrieve a relevant encrypted first data element of the stored plurality of encrypted first data elements based on the identified data as described in step 3 of FIG. 5B above. For example, system 100 may compare the identified data with the metadata associated with each encrypted first data element. If the identified data indicates that at least one of network identity 130 or the additional network identity is requesting access to a specific type of resource, system 100 may select the encrypted first data element with metadata that matches the specific type of resource. Additionally or alternatively, metadata may include tags or attributes that correspond to various aspects of the request, network identity 130, or the additional network identity, such as user role, time of access, location, or device type. System 100 may use these tags to filter and identify the most appropriate encrypted first data element for each request.

In some embodiments, identifying the relevant encrypted first data element may be performed by a machine learning model. For example, the machine learning model may be trained on historical data to recognize patterns or relationships between request characteristics and the most suitable encrypted data elements. Additionally or alternatively, the machine learning model may process multiple contextual signals associated with the request and at least one of network identity 130 or the additional network identity. In some embodiments, the machine learning model may process one or more of the request (e.g., type, content, parameters), network identity 130, metadata associated with network identity 130, the additional network identity, metadata associated with the additional network identity, a time of the request, source IP address, details about the requested resource, historical activity (e.g., past events, request history), communication protocol type and standard fields, or the client or application from which the request originates. For example, the machine learning model may infer which data element should be decrypted based on the communication protocol in use. Additionally or alternatively, the machine learning model may select the element that best aligns with prior activity associated with at least one of network identity 130 or the additional network identity and context of the current request.

In some embodiments, system 100 may configure the machine learning model to leverage patterns learned from historical data to make context-aware selections. This may allow for more accurate identification of the relevant encrypted first data element compared to static rule-based methods. In some embodiments, the machine learning model may evaluate multiple signals together to determine which encrypted first data element of the stored plurality of encrypted first data elements is most appropriate for the specific request. In some embodiments, the machine learning model may comprise a large language model.

In some embodiments, system 100 may generate a random value and nonce to initiate a challenge-response protocol for identity validation as described in step 4 of FIG. 5B above. At least one of network identity 130 or the additional network identity may receive and process the nonce using a private key (e.g., of the key pair) as described in step 5 of FIG. 5B above. Additionally or alternatively, at least one of network identity 130 or the additional network identity may generate a first response and authentication system 101 may receive and validate the first response as described in steps 6 and 7 of FIG. 5B above.

In step 640, system 100 may dynamically determine a second data element based on fields of a communication protocol as described in steps 8 and 9 of FIG. 5B above. For example, the second data element may be used to decrypt the encrypted first data element. In some embodiments, system 100 may identify and select relevant standard fields of the communication protocol based on the identified attributes from the request. For example, system 100 may use fields from SSH, RDP, or other protocols depending on the type of connection being established. In some embodiments, system 100 may employ machine learning models to assist in selecting the most relevant fields for each request context.

In some embodiments, system 100 may determine the second data element based on the identified data associated with at least one of the network identity 130, additional network identity, or the request. For example, system 100 may use the actual values of the identified data to refine the determination of the second data element. System 100 may process the specific content of fields such as IP address, user role, or client type to make more nuanced decisions. In some embodiments, system 100 may perform a two-step process starting with selecting relevant protocol fields based on the identified data, and then using the values of these fields for further refinement. For instance, system 100 may select the IP address field as relevant, and then use the specific IP address to differentiate between requests originating from within the organization's network and those from external sources. Additionally or alternatively, system 100 may utilize machine learning models to analyze the identified data and determine the most appropriate second data element for each unique request context. This approach may allow system 100 to adapt to various network environments and security requirements.

In step 650, system 100 may decrypt the first data element using the second data element (e.g., identified data) as described in step 10 of FIG. 5B above. For example, system 100 may use role-based decryption where the role of network identity 130 (e.g., Administrator, Standard User) or the additional network identity determines the decryption process. When network identity 130 requests access to a sensitive resource, system 100 may identify the role of network identity 130 or the additional network identity and derive (e.g., map) the decryption key for the first data element based on this role. In some cases, only users associated with the appropriate role may successfully decrypt the data element, while others may be denied access or receive a different key. Additionally or alternatively, system 100 may employ location or IP-based decryption. For example, system 100 may use the IP address and location of network identity 130 or the additional network identity as identified data. When at least one of network identity 130 or the additional network identity attempts to access a secure zone from a specific IP address, system 100 may check if the IP address and geolocation match a trusted secure zone. In some cases, the decryption key for the first data element may only be valid if the request originates from that specific IP or location. If the request comes from outside the secure zone, decryption may fail or require additional authentication steps.

In some embodiments, system 100 may utilize a combination of multiple identified data points to determine the decryption process. For example, system 100 may consider both the role and the location of at least one of network identity 130 or the additional network identity when determining the process for decrypting the first data element. This approach may allow for more granular access control and enhanced security measures.

In some embodiments, system 100 may dynamically decrypt the first data element. For example, dynamic decryption may involve adapting the decryption method based on various factors present at the time of the request. In some embodiments, system 100 may utilize different decryption algorithms or keys depending on the context of the request. In some embodiments, system 100 may employ a multi-layer decryption approach. For example, the first data element may be encrypted using multiple layers of encryption, each layer corresponding to a different aspect of the request, network identity 130, or the additional network identity. System 100 may dynamically determine which layers to decrypt based on the current context and the identified data associated with the request. Additionally or alternatively, system 100 may use a key derivation function that incorporates real-time data to generate the decryption key. For example, the key derivation function may combine the second data element calculated from the communication protocol fields with other dynamic factors such as a timestamp or a randomly generated nonce.

This approach may enhance security by ensuring that the decryption key is unique for each request, even if the same network identity is accessing the same resource multiple times.

In some embodiments, system 100 may implement a threshold decryption scheme. For example, system 100 may require multiple conditions to be met before proceeding with decryption. System 100 may dynamically evaluate such conditions based on a current system state, network conditions, or other relevant factors. System 100 may assign weights to different conditions and only proceed with decryption if a certain threshold is met. Additionally or alternatively, system 100 may implement a time-based dynamic decryption scheme. For example, the decryption process may vary depending on the time of day, day of the week, or specific time windows defined by system administrators. This approach may allow for stricter decryption requirements during off-hours or high-risk periods.

In some embodiments, system 100 may use machine learning models to enhance dynamic decryption. For example, system 100 may use machine learning models trained on historical access patterns and security events to predict appropriate decryption methods for a given request. In some embodiments, the machine learning models may analyze patterns in the identified data and dynamically adjust the decryption process based on evolving security requirements or threat landscapes. Additionally or alternatively, the machine learning models may continuously learn and adapt based on new data, allowing the system to improve prediction and analysis over time.

In some embodiments, system 100 may dynamically decrypt the first data element based on context. For example, system 100 may consider the broader context of the request, such as concurrent access attempts, recent security events, or system load, when determining how to decrypt the first data element. This may allow system 100 to adapt its decryption strategy in response to potential security threats or unusual activity patterns.

In some embodiments, decrypting may involve combining the second data element with other stored keys or using it as input to a key derivation function. In some embodiments, system 100 may use hardware security modules to perform the decryption for enhanced security.

In step 660, system 100 may perform the action on the resource using the first data element as described in step 11 of FIG. 5B above. The action may include establishing a secure connection, retrieving data, or executing commands on the resource. In some embodiments, system 100 may log the performed action for auditing purposes or apply additional access controls based on the decrypted first data element. Step 660 may be implemented in a similar manner to step 470 of FIG. 4 described above. In some embodiments, system 100 may send a response to the network identity or additional network identity confirming successful completion of the action associated with resource 140.

Method 600 may conclude at stop 699. System 100 may repeat method 600 for subsequent requests or periodically to refresh stored encrypted data elements.

Various operations or functions are described herein, which may be implemented or defined as software code or instructions. Such content may be directly executable (“object” or “executable” form), source code, or difference code (“delta” or “patch” code). Software implementations of the embodiments described herein may be provided via an article of manufacture with the code or instructions stored thereon, or via a communication interface method to send data via the communication interface. A machine or computer readable storage medium may cause a machine to perform the functions or operations described and includes any mechanism that stores information in a form accessible by a machine (e.g., computing device, electronic system, and the like), such as recordable/non-recordable media (e.g., read only memory (ROM), random access memory (RAM), magnetic disk storage media, optical storage media, flash memory devices, and the like). A communication interface includes any mechanism that interfaces with any of a hardwired, wireless, optical, or similar, medium to communicate with another device, such as a memory bus interface, a processor bus interface, an Internet connection, a disk controller, and the like. The communication interface may be configured by providing configuration parameters and/or sending signals to prepare the communication interface to provide a data signal describing the software content. The communication interface may be accessed via one or more commands or signals sent to the communication interface.

The present disclosure also relates to a system for performing the operations herein. This system may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Embodiments of the present disclosure may be implemented with computer executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

Computer programs based on the written description and methods of this specification are within a software developer’s skill. The various programs or program modules may be created using a variety of programming techniques. For example, program sections or program modules may be designed by means of JavaScript, Scala, Python, Java, C, C++, assembly language, or any such programming languages, as well as data encoding languages (such as XML, JSON, etc.), query languages (such as SQL), presentation-related languages (such as HTML, CSS, etc.) and data transformation language (such as XSL). One or more of such software sections or modules may be integrated into a computer system, non-transitory computer readable media, or existing communications software.

The words “comprising,” “having,” “containing,” and “including,” and other similar forms are intended to be equivalent in meaning and be interpreted as open ended, in that, an item or items following any one of these words is not meant to be an exhaustive listing of such item or items, or meant to be limited to only the listed item or items. In addition, the singular forms “a,” “an,” and “the” are intended to include plural references, unless the context clearly dictates otherwise.

Having described aspects of the embodiments in detail, it will be apparent that modifications and variations are possible without departing from the scope of aspects of the invention as defined in the appended claims. As various changes could be made in the above constructions, products, and methods without departing from the scope of aspects of the invention, it is indented that all matter contained in the above description and shown in the accompanying drawings shall be interpreted as illustrative and not in a limiting sense.

What is claimed is:

1. A non-transitory computer readable medium including instructions that, when executed by at least one processor, cause the at least one processor to perform operations when using a network identity, the operations comprising:
encrypting a first data element;
storing the encrypted first data element, wherein the encrypted first data element is mapped to a network identity;
receiving a request from the network identity or from an additional network identity associated with the network identity to perform an action on a resource;
dynamically determining a second data element based on fields of a communication protocol;
decrypting the first data element using the second data element; and
performing the action on the resource using the first data element.

2. The non-transitory computer readable medium of claim 1, the operations further comprising identifying data associated with at least one of the network identity, additional network identity or the request.

3. The non-transitory computer readable medium of claim 2, wherein identifying relevant standard fields of the communication protocol is based on the identified data.

4. The non-transitory computer readable medium of claim 2, wherein the identified data includes at least one of a username of the network identity or the additional network identity, a group the network identity or the additional network identity is associated with, a role the network identity or the additional network identity is associated with, a type of authentication used for the network identity or the additional network identity, an internet protocol (IP) address associated with the network identity or the additional network identity, a type of client associated with the network identity or the additional network identity, a location of the network identity or the additional network identity, a network provider for the network identity or the additional network identity, a license associated with the network identity or the additional network identity, a type of native communication protocol, a selected cipher suite, the resource associated with the request, metadata associated with the resource associated with the request, the action associated with the request, the communication protocol, secure zone information, a time of the request, or a device identifier.

5. The non-transitory computer readable medium of claim 2, wherein decrypting the first data element is based on the identified data.

6. The non-transitory computer readable medium of claim 2, wherein determining the second data element is based on identified data associated with at least one of the network identity or the request.

7. The non-transitory computer readable medium of claim 1, the operations further comprising obtaining a plurality of first data elements.

8. The non-transitory computer readable medium of claim 1, wherein decrypting the first data element is performed dynamically.

9. The non-transitory computer readable medium of claim 7, wherein encrypting the first data element comprises encrypting the plurality of first data elements.

10. The non-transitory computer readable medium of claim 9, wherein storing the encrypted first data element comprises storing the plurality of encrypted first data elements.

11. The non-transitory computer readable medium of claim 9, wherein each encrypted first data element of the plurality of encrypted first data elements is mapped to the network identity.

12. The non-transitory computer readable medium of claim 10, wherein the operations further comprising:
identifying data associated with at least one of the network identity, the additional network identity or the request; and
identifying a relevant encrypted first data element of the stored plurality of encrypted first data elements based on the identified data.

13. The non-transitory computer readable medium of claim 9, wherein storing the encrypted first data element comprises storing the plurality of encrypted first data elements with metadata associated with each encrypted first data element.

14. The non-transitory computer readable medium of claim 12, wherein identifying the relevant encrypted first data element is performed by a machine learning model.

15. The non-transitory computer readable medium of claim 14, wherein the machine learning model comprises a large language model.

16. A computer-implemented method comprising:
encrypting a first data element;
storing the encrypted first data element, wherein the encrypted first data element is mapped to a network identity;
receiving a request from the network identity or from an additional network identity associated with the network identity to perform an action on a resource;
dynamically determining a second data element based on fields of a communication protocol;
decrypting the first data element using the second data element; and
performing the action on the resource using the first data element.

17. A non-transitory computer readable medium including instructions that, when executed by at least one processor, cause the at least one processor to perform operations when using a network identity, the operations comprising:
obtaining a first data element;
encrypting the first data element;
storing the encrypted first data element, wherein the encrypted first data element is mapped to a network identity;
receiving a request from the network identity to perform an action on a resource;
authenticating the network identity;
decrypting the first data element, based on a determination that a trigger event associated with the authentication has occurred, wherein the trigger event is configured using a configuration setting stored in association with the action provided in the request; and
enabling the action on the resource using the first data element.

18. The non-transitory computer readable medium of claim 17, wherein the first data element is generated by an authentication engine based on data sent by the network identity.

19. The non-transitory computer readable medium of claim 17, wherein the first data element comprises a credential required to access the resource.

20. The non-transitory computer readable medium of claim 17, wherein the encrypted first data element is stored in a memory location that is inaccessible to the network identity until authentication is complete.
.
